(19) United States
(12) Patent Application Publication
(10) Pub. No.: US 2017/0326851 A1
(43) Pub. Date: Nov. 16, 2017

(54) OPTICAL FILM, FLEXIBLE DEVICE MEMBER COMPRISING THE OPTICAL FILM, AND RESIN COMPOSITION

(71) Applicants: SUMITOMO CHEMICAL COMPANY, LIMITED, Tokyo (JP); Industrial Technology Research Institute, Chutung Hsinchu (TW)

(72) Inventors: Katsunori MOCHIZUKI, Osaka (JP); Kazumasa UEDA, Tokyo (JP); Akiko KISHIDA, Tsukuba-shi (JP); Tzong Ming LEE, Chutung Hsinchu (TW); Chyi Ming LEU, Chutung Hsinchu (TW); Chih Cheng LIN, Chutung Hsinchu (TW); Yung-Lung TSENG, Chutung Hsinchu (TW)

(73) Assignees: SUMITOMO CHEMICAL COMPANY, LIMITED, Tokyo (JP); Industrial Technology Research Institute, Chutung Hsinchu (TW)

(21) Appl. No.: 15/590,272

(22) Filed: May 9, 2017

(30) Foreign Application Priority Data
May 10, 2016 (JP) 2016-094348

(51) Int. Cl. B32B 27/28; B32B 27/36; C08K 5/16

(52) U.S. Cl. CPC B32B 27/283; C08K 5/16; B32B 27/36; C08J 2379/08

(57) ABSTRACT

To provide an optical film having improved bending resistance while maintaining optical characteristics, e.g. transparency, total light transmittance, and YI value and so on. An optical film containing a resin and silica fine particles whose average primary particle size measured by image analysis with a scanning electron microscope is not less than 21 nm and not more than 40 nm, wherein the content of the silica fine particles is not less than 15% by mass and not more than 80% by mass based on a total content of the resin and the silica fine particles.

### BACKGROUND OF THE INVENTION

### Field of the Invention

The present invention relates to a film, a flexible device member comprising the film, and a resin composition.

### Description of the Related Art

As a trend in recent years, a lightweight display having a slim shape and achieving display without unevenness on a non-flat surface is required. Thus, a soft and flexible display substrate has been recently developed as a substitute for a glass plate.

In order to achieve this object, as a flexible plastic substrate, a polycarbonate substrate, a polyethylene terephthalate substrate, a polyimide substrate, and the like have been developed to be used in flat panel displays.

For example, JP-A-2009-215412 reports that a polyimide film which is excellent in transparency, flexibility, and folding resistance while maintaining original physical properties can be obtained from a polyimide resin composition dispersed with finely divided silica.

### SUMMARY OF THE INVENTION

However, if a ratio of silica fine particles in a resin composition increases, there is a tendency that while the modulus of elastic modulus of a film to be formed is increased, the bending resistance is reduced. Therefore, improvement of the bending resistance is an object for use as a member for a flexible display. Suppression of a change with time in viscosity of a resin composition containing silica fine particles is important for film thickness stabilization in continuous film formation.

An object of the present invention is to provide an optical film which has improved bending resistance while maintaining the optical characteristics, e.g. transparency, total light transmittance, and YI value, etc., a flexible device member comprising the optical film, and a resin composition allowing for formation of an optical film which has improved bending resistance while maintaining the optical characteristics, e.g. transparency, total light transmittance, and YI value and so on.

The present inventors found that the above-described problem can be solved by using silica fine particles having an average particle size within a specific range, allowing the present invention to be achieved.

Namely, the present invention relates to the following [1] to [12].
[1] An optical film containing a resin and silica fine particles whose average primary particle size measured by image analysis with a scanning electron microscope is not less than 21 nm and not more than 40 nm, wherein the content of the silica fine particles is not less than 15% by mass and not more than 80% by mass based on a total content of the resin and the silica fine particles.
[2] The optical film as described in [1] above, wherein the resin contains a polyimide-based polymer.
[3] The optical film as described in [1] or [2] above, wherein the average primary particle size of the silica fine particles measured by image analysis with a scanning electron microscope is not less than 25 nm and not more than 40 nm.
[4] The optical film as described in any one of [1] to [3] above, wherein a variation coefficient of the silica fine particles obtained by image analysis with a scanning electron microscope is more than 0 and not more than 0.5.
[5] The optical film as described in any one of [1] to [4] above, wherein the content of the silica fine particles is not less than 25% by mass and not more than 60% by mass based on a total content of the resin and the silica fine particles.
[6] The optical film as described in any one of [1] to [5] above, further containing an alkoxysilane compound having a reactive group and contained in an amount of not less than 0.1 parts by mass and not more than 3 parts by mass based on 100 parts by mass of a total content of the resin and the silica fine particles.
[7] The optical film as described in any one of [1] to [6] above, wherein a total light transmittance at a film thickness of 50 μm is not less than 85%, and a haze is not more than 2.0.
[8] The optical film as described in any one of [1] to [7] above, wherein a film thickness is not less than 20 μm and not more than 200 μm.
[9] A flexible device member comprising the optical film according to any one of [1] to [8] above.
[10] A resin composition comprising a resin containing a polyimide-based polymer and silica fine particles whose volume average primary particle size measured by a BET method is not less than 16 nm and not more than 40 nm and an average particle size measured by a dynamic light scattering method is not less than 25 nm and not more than 65 nm.
[11] The resin composition as described in [10] above, wherein the content of the silica fine particles is not less than 15% by mass and not more than 80% by mass based on a total content of the resin and the silica fine particles.
[12] The polyimide-based resin composition as described in [10] or [11] above, wherein a polydispersity index of a volume average particle size of the silica fine particles measured by the dynamic light scattering method is not more than 15%.
[13] An optical film comprising the resin composition as described in any one of [10] to [12] above.

According to this invention, the particle size of silica fine particles contained in the optical film is optimized, whereby while optical characteristics, e.g. transparency, total light transmittance, and YI value, etc., of the optical film are maintained, the bending resistance can be improved. Further, this invention can provide a flexible device member comprising the optical film. Furthermore, this invention can provide a resin composition (a hybrid varnish) which allows for formation of an optical film, which has improved bending resistance while maintaining the optical characteristics, e.g. transparency, total light transmittance, and YI value, etc., and has improved stability of viscosity.

### BRIEF DESCRIPTION OF THE DRAWINGS

FIG. 1 is a SEM image of an optical film obtained in Example 2;

FIG. 2 is a SEM image of an optical film obtained in Example 4;

FIG. 3 is a SEM image of an optical film obtained in Example 5;

FIG. 4 is a SEM image of an optical film obtained in Example 6;

FIG. 5 is a SEM image of an optical film obtained in Example 7;

FIG. 6 is a SEM image of an optical film obtained in Comparative Example 4.

### DETAILED DESCRIPTION OF THE PREFERRED EMBODIMENTS

Hereinafter, some embodiments of the present invention will be described in detail. However, this invention is not limited to the following embodiments.

In this specification, polyimide is a polymer mainly containing a repeating structural unit containing an imide group, polyamide is a polymer mainly containing a repeating structural unit containing an amide group, and a polyimide-based polymer denotes polyimide and a polymer mainly containing a structural unit containing an imide group and a structural unit containing an amide group. Examples of the polymer mainly containing the structural unit containing an imide group and the structural unit containing an amide group include polyamideimide.

An optical film (hereinafter also referred to simply as a film) according to this invention is a film characterized by containing at least one or more kinds of resins and silica fine particles whose average primary particle size measured by image analysis with a scanning electron microscope is not less than 21nm and not more than 40 nm, wherein the content of the silica fine particles is not less than 15% by mass and not more than 80% by mass based on a total content of the resin and the silica fine particles.

Examples of the resin according to this embodiment include a polyimide-based polymer, polyamide, polyester, poly(meth)acrylate, acetyl cellulose, polyethylene terephthalate, polyethylene naphthalate, cycloolefin polymer, and other copolymers thereof. In terms of excellent transparency, heat resistance, and various mechanical properties, preferred is a polyimide-based polymer and polyamide, more preferred is polyimide-based polymer. One or two or more kinds of resins may be contained.

The polyimide-based polymer according to this embodiment can be produced by using, as main raw materials, a tetracarboxylic compound and a diamine compound to be described later and has a repeating structural unit represented by the following formula (10). Here, G denotes a tetravalent organic group, and A denotes a divalent organic group. The polyimide-based polymer may include two or more types of the structures having different G and/or A and represented by the formula (10). The polyimide-based polymer according to this embodiment may include one or more kinds of structures represented by the formulae (11), (12), and (13) as long as various physical properties of a polyimide-based polymer film to be obtained are not impaired.

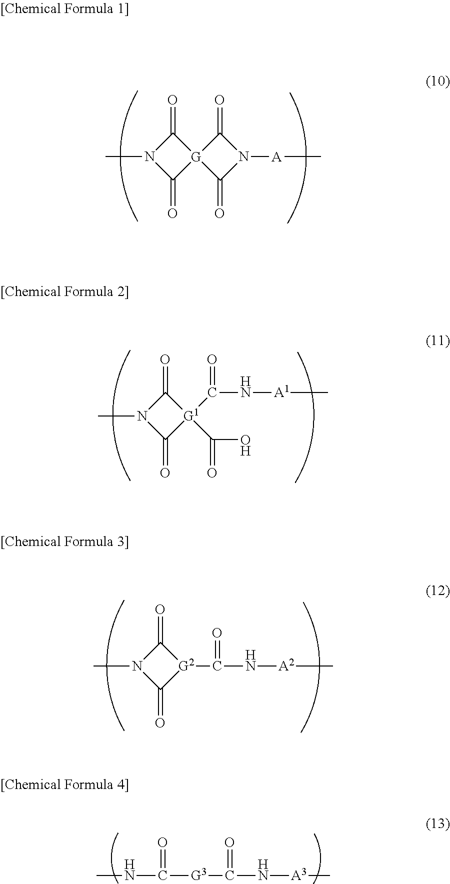

G and G¹ denote tetravalent organic groups and preferably organic groups optionally substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G and G¹ include a group represented by the following formula (20), (21), (22), (23), (24), (25), (26), (27), (28), or (29) and a tetravalent chain hydrocarbon group having not more than 6 carbon atoms are exemplified. In the formulae, “*” denotes a bonding site, and Z denotes a single bond, —O—, —CH₂—, —CH₂—CH₂—, —CH(CH₃)—, —C(CH₃)₂—, —C(CF₃)₂—, —Ar—, —SO₂—, —CO—, —O—Ar—O—, —Ar—O—Ar—, —Ar—CH₂—Ar—, —Ar—C(CH₃)₂—Ar—, or —Ar—SO₂—Ar—. Ar denotes an arylene group having 6 to 20 carbon atoms optionally substituted with fluorine atoms and specific examples thereof include a phenylene group, a naphthalene group and a group having a fluorene ring. From viewpoint of suppressing yellow index of the produced film, a group represented by the following formula (20), (21), (22), (23), (24), (25), (26), or (27) is preferred.

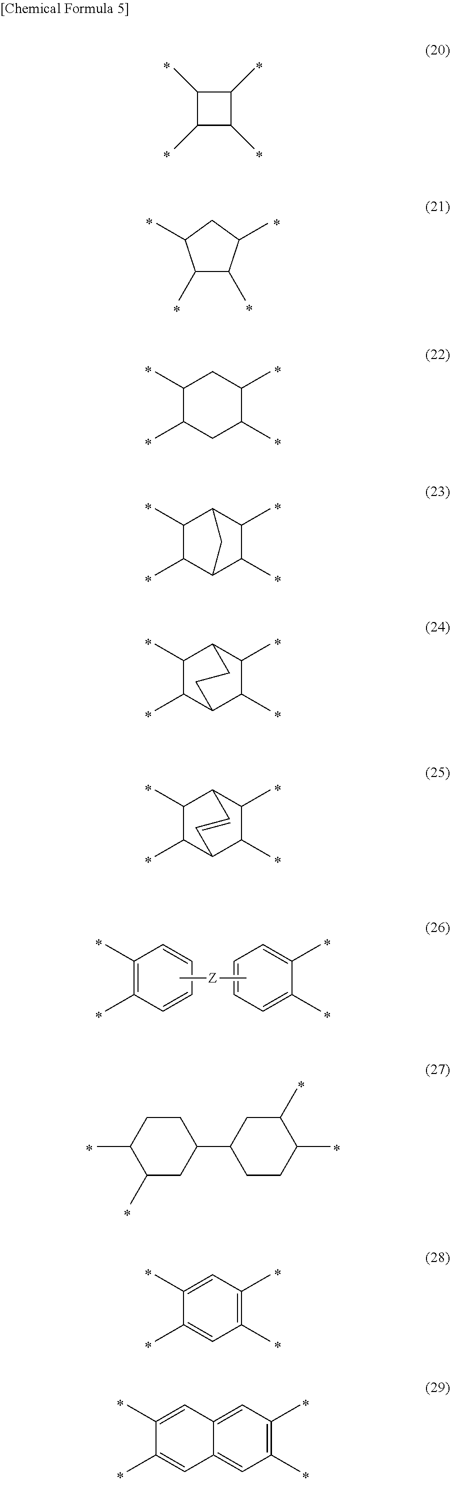

G² denotes a trivalent organic group and preferably an organic group optionally substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G² includes a group in which any one of bonding sites of groups represented by the above formulae (20), (21), (22), (23), (24), (25), (26), (27), (28), and (29) is replaced by a hydrogen atom and a trivalent chain hydrocarbon group having not more than 6 carbon atoms are exemplified.

G³ denotes a bivalent organic group and preferably an organic group optionally substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G³ includes a group in which, among the bonding sites of the groups represented by the above formulae (20), (21), (22), (23), (24), (25), (26), (27), (28), and (29), two of them not adjacent to each other are replaced by hydrogen atoms and a chain hydrocarbon group having not more than 6 carbon atoms are exemplified.

A, A¹, A², and A³ each denote a bivalent organic group and preferably denote an organic group optionally substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples thereof include groups represented by the following formulae (30), (31), (32), (33), (34), (35), (36), (37), and (38), groups in which these groups are substituted with a methyl group, a fluoro group, a chloro group, or a trifluoromethyl group, and a chain hydrocarbon group having not more than 6 carbon atoms. In the formulae, “*” denotes a bonding site, and Z¹, Z², and Z³ each independently denote a single bond, —O—, —CH₂—, —CH₂—CH₂—, —CH (CH₃) —, —C(CH₃)₂—, —C (CF₃)₂—, —SO₂—, or —CO—. As one example, Z¹ and Z³ may be —O—, and Z² may be —CH₂—, —C(CH₃)₂—, —C (CF₃)₂—, or —SO₂—. Z¹ and Z², and Z² and Z³ are each preferably located at a meta position or a para position with respect to each ring.

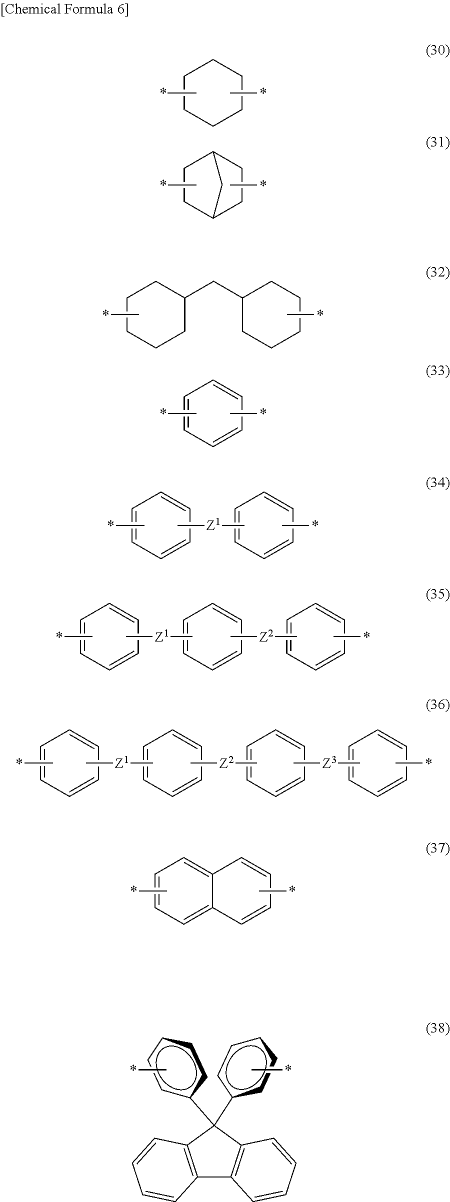

Polyamide according to this embodiment is a polymer mainly containing the repeating structural unit represented by the above formula (13). Preferred and specific examples are the same as given in G³ and A³ in the polyimide-based polymer. Polyamide may include two or more types of the structures having different G³ and/or A³ and represented by the formula (13).

A polyimide-based polymer is obtained by polycondensation of diamine and a tetracarboxylic compound (such as tetracarboxylic dianhydride), for example, and can be synthesized in accordance with the method disclosed in JP-A-2006-199945 or JP-A-2008-163107, for example. Examples of commercially available products of polyimide-based polymer include Neopulim manufactured by Mitsubishi Gas Chemical Co., Inc.

Examples of a tetracarboxylic compound used for synthesis of polyimide-based polymer include aromatic tetracarboxylic compounds such as aromatic tetracarboxylic dianhydride and aliphatic tetracarboxylic compounds such as aliphatic tetracarboxylic dianhydride. The tetracarboxylic compound may be used alone, or two or more kinds thereof may be mixed and used. The tetracarboxylic compound may be a tetracarboxylic compound analog such as an acid chloride compound, in addition to a dianhydride.

Specific examples of the aromatic tetracarboxylic dianhydride include 4,4′-oxydiphthalic acid dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 3,3′,4,4′-diphenylsulfonetetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenoxyphenyl)propane dianhydride, 4,4′-(hexafluoroisopropylidene)diphthalic dianhydride, 1,2-bis(2,3-dicarboxyphenyl)ethane dianhydride, 1,1-bis(2,3-dicarboxyphenyl)ethane dianhydride, 1,2-bis(3,4-dicarboxyphenyl)ethane dianhydride, 1,1-bis(3,4-dicarboxyphenyl)ethane dianhydride, bis(3,4-dicarboxyphenyl)methane dianhydride, bis(2,3-dicarboxyphenyl)methane dianhydride, 4,4′-(p-phenylenedioxy)diphthalic dianhydride, and 4,4′-(m-phenylenedioxy)diphthalic dianhydride. These can be used alone or in combination of two or more kinds thereof.

Examples of the aliphatic tetracarboxylic dianhydride include cyclic or acyclic aliphatic tetracarboxylic dianhydride. The cyclic aliphatic tetracarboxylic dianhydride is a tetracarboxylic dianhydride having an alicyclic hydrocarbon structure, and specific examples thereof include cycloalkane-tetracarboxylic dianhydrides such as 1,2,4,5-cyclohexanetetracarboxylic dianhydride, 1,2,3,4-cyclobutanetetracarboxylic dianhydride, and 1,2,3,4-cyclopentanetetracarboxylic dianhydride, bicyclo[2.2.2]oct-7-ene-2,3,5,6-tetracarboxylic dianhydride, dicyclohexyl-3,3′-4,4′-tetracarboxylic dianhydride, and their regioisomers. These can be used alone or in combination of two or more kinds thereof. Specific examples of the alicyclic aliphatic tetracarboxylic dianhydride include 1,2,3,4-butanetetracarboxylic dianhydride and 1,2,3,4-pentanetetracarboxylic dianhydride, and these can be used alone or in combination of two or more kinds thereof.

Among those tetracarboxylic dianhydrides, from viewpoints of high transparency and low colorability, 1,2,4,5-cyclohexanetetracarboxylic dianhydride, bicyclo[2.2.2]oct-7-ene-2,3,5,6-tetracarboxylic dianhydride, and4,4′-(hexafluoroisopropylidene)diphthalicdianhydride are preferable.

The polyimide-based polymer according to this embodiment may be those further reacted with tetracarboxylic acid, tricarboxylic acid, dicarboxylic acid, and anhydrides and derivatives thereof, in addition to an anhydride of tetracarboxylic acid used for the synthesis of polyimide-based polymer, as long as various physical properties of a film containing a polyimide-based polymer to be obtained are not impaired.

Examples of a tricarboxylic compound include aromatic tricarboxylic compounds, aliphatic tricarboxylic compounds, and acid chloride compounds and acid anhydrides similar thereto, and two or more kinds thereof may be mixed and used. Specific examples include 1,2,4-benzenetricarboxylic anhydride; 2,3,6-naphthalenetricarboxylic acid-2,3-anhydride; and a compound in which phthalic anhydride and benzoic acid are bonded together through a single bond, —O—, —CH₂—, —C(CH₃)₂—, —C(CF₃)₂—, —SO₂—, or a phenylene group.

Examples of a dicarboxylic compound include aromatic dicarboxylic compounds, aliphatic dicarboxylic compounds, and acid chloride compounds and acid anhydrides similar thereto, and two or more kinds thereof may be mixed and used. Specific examples include terephthalic acid; isophthalic acid; naphthalenedicarboxylic acid; 4,4′-biphenyldicarboxylic acid; 3,3′-biphenyldicarboxylic acid; and a compound in which a dicarboxylic compound of a chain hydrocarbon group having not more than 8 carbon atoms and two benzoic acids are bonded together through a single bond, —O—, —CH₂—, —C(CH₃)₂—, —C(CF₃)₂—, —SO₂—, or a phenylene group.

As diamine used for synthesis of polyimide-based polymer, aliphatic diamine, aromatic diamine, or mixtures thereof may be used. In this embodiment, the “aromatic diamine” means a diamine containing an amino group directly bonded to an aromatic ring, which may also contain an aliphatic group or another substituent group as a part of a structure thereof. The aromatic ring may be a single ring or a condensed ring, and a benzene ring, a naphthalene ring, an anthracene ring, and a fluorene ring are exemplified. However, this invention is not limited thereto. Among them, the benzene ring is preferable. The “aliphatic diamine” means a diamine containing an amino group directly bonded to an aliphatic group, which may also contain an aromatic ring or another substituent group as a part of a structure thereof.

Examples of the aliphatic diamine include acyclic aliphatic diamines such as hexamethylenediamine and cyclic aliphatic diamines such as 1,3-bis(aminomethyl)cyclohexane, 1,4-bis(aminomethyl)cyclohexane, norbornanediamine, and 4,4′-diaminodicylcohexyl methane, and these can be used alone or in combination of two or more kinds thereof.

Examples of the aromatic diamine include aromatic diamines having one aromatic ring, such as p-phenylenediamine, m-phenylenediamine, 2, 4-toluenediamine, m-xylylenediamine, p-xylylenediamine, 1,5-diaminonaphthalene, and 2,6-diaminonaphthalene, and aromatic diamines having two or more aromatic rings, such as 4,4′-diaminodiphenyl methane, 4,4′-diaminodiphenyl propane, 4,4′-diaminodiphenyl ether, 3,4′-diaminodiphenyl ether, 3,3′-diaminodiphenyl ether, 4,4′-diaminodiphenyl sulfone, 3,4′-diaminodiphenyl sulfone, 3,3′-diaminodiphenyl sulfone, 1,4-bis(4-aminophenoxy)benzene, 1,3-bis(4-aminophenoxy)benzene, 4,4′-diaminodiphenylsulfone, bis[4-(4-aminophenoxy)phenyl]sulfone, bis[4-(3-aminophenoxy)phenyl]sulfone, 2,2-bis[4-(4-aminophenoxy)phenyl]propane, 2,2-bis[4-(3-aminophenoxy)phenyl]propane, 2,2′-dimethylbenzidine, 2,2′-bis(trifluoromethyl)benzidine, 4,4′-bis(4-aminophenoxy)biphenyl, 4,4′-diaminodiphenylether, 3,4′-diaminodiphenyl ether, 4,4′-diaminodiphenyl methane, 9,9-bis(4-aminophenyl)fluorene, 9,9-bis(4-amino-3-methylphenyl)fluorene, 9,9-bis(4-amino-3-chlorophenyl)fluorene, and 9,9-bis(4-amino-3-fluorophenyl)fluorene. These can be used alone or in combination of two or more kinds thereof.

Among those diamines, from viewpoints of high transparency and low colorability, it is preferable to use one or more kinds selected from the group consisting of aromatic diamines having a biphenyl structure. It is more preferable to use one or more kinds selected from the group consisting of 2,2′-dimethylbenzidine, 2,2′-bis(trifluoromethyl)benzidine, 4,4′-bis(4-aminophenoxy)biphenyl, 2,2-bis[4-(4-aminophenoxy)phenyl]propane, and 4,4′-diaminodiphenyl ether, and it is still more preferable to contain 2,2′-bis(trifluoromethyl)benzidine.

A polyimide-based polymer and polyamide which are polymers containing at least one type of repeating structural unit represented by the formulae (10), (11), (12), or (13) are condensate polymers which are each a polycondensation product of diamine and at least one kind of compound included in the group consisting of a tetracarboxylic compound (tetracarboxylic compound analog such as an acid chloride compound and tetracarboxylic dianhydride), a tricarboxylic compound (tricarboxylic compound analog such as an acid chloride compound and tricarboxylic anhydride), and a dicarboxylic compound (dicarboxylic compound analog such as an acid chloride compound). As a starting material, in addition to them, a dicarboxylic compound (including analogs such as an acid chloride compound) may be further used. The repeating structural unit represented by the formula (11) is usually derived from diamines and a tetracarboxylic compound. The repeating structural unit represented by the formula (12) is usually derived from diamine and a tricarboxylic compound. The repeating structural unit represented by the formula (13) is usually derived from diamine and a dicarboxylic compound. Specific examples of diamine and the tetracarboxylic compound are as described above.

The polyimide-based polymer and polyamide according to this embodiment may each have a weight average molecular weight within the range of 10,000 to 500,000 in terms of standard polystyrene. The weight average molecular weight is preferably within the range of 50,000 to 500,000 and more preferably within the range of 100,000 to 400,000. When the weight average molecular weight of the polyimide-based polymer and the polyamide is too small, properties of bending resistance in forming a film tends to be lower. The greater the weight average molecular weight of the polyimide-based polymer and the polyamide is, the greater the tendency that high bending resistance is likely to be exhibited in forming a film is. However, if the weight average molecular weight of the polyimide-based polymer and polyamide is too high, there is a tendency that viscosity of a varnish increases to deteriorate processability.

When the polyimide-based polymer and the polyamide each contain a fluorine-containing substituent group, there is a tendency that while the elastic modulus in forming a film increases, the YI value is reduced. If the elastic modulus of the film is high, flaws, wrinkles and the like tend to be suppressed. From the viewpoint of transparency of a film, the polyimide-based polymer and the polyamide preferably each have a fluorine-containing substituent group. Specific examples of the fluorine-containing substituent group include a fluoro group and a trifluoromethyl group.

The content of fluorine atoms in the polyimide-based polymer and the polyamide is preferably not less than 1% by mass and not more than 40% by mass and more preferably not less than 5% by mass and not more than 40% by mass based on the mass of the polyimide-based polymer or the polyamide.

It is preferable that the silica fine particles according to this embodiment be particles of silicon dioxide and be amorphous. Examples of the shape of the silica fine particles include a spherical shape, a spheroidal shape, a flat ellipsoidal shape, and a chain-like shape.

In the silica fine particles according to this embodiment, it is preferable, in terms of exhibition of good optical characteristics in a film, that the primary particle size measured by image analysis with a scanning electron microscope be small. On the other hand, in terms of excellent bending resistance in a film or ease of handling silica fine particles in a resin composition state due to weakening of a cohesive force between the silica fine particles, it is preferable that the average primary particle size be relatively large. The average primary particle size is not less than 21 nm and not more than 40 nm, preferably not less than 23 nm and not more than 40 nm, more preferably not less than 25 nm and not more than 40 nm. In one embodiment of the present invention, further preferably not less than 25 nm and not more than 35 nm, further more preferably not less than 26 nm and not more than 33 nm. In another embodiment of the present invention, further preferably not less than 28 nm and not more than 37 nm, further more preferably not less than 31 nm and not more than 37 nm, and most preferably not less than 32 nm and not more than 36 nm.

The average primary particle size of silica fine particles in the film can be obtained by image analysis with a scanning electron microscope (SEM).

Distribution of the particle size of the silica fine particles according to this embodiment can be converted to numbers by a variation coefficient obtained by dividing the average primary particle size by the standard deviation. The the variation coefficient of the silica fine particles is preferably more than 0 and not more than 0.5 and more preferably more than 0 and not more than 0.4 because if the variation coefficient is small, it is possible to avoid deterioration of the optical characteristics accompanying the presence of fine particles having a relatively large particle size. In the evaluation method, the variation coefficient can generally be 0.2 or more.

The film according to this embodiment contains the silica fine particles in an amount of not less than 15% by mass and not more than 80% by mass based on a total content (100% by mass) of the resin and the silica fine particles. The content of the silica fine particles is preferably high in terms of increases in the total light transmittance of the film and the elastic modulus and a reduction in material cost, and, on the other hand, the content of the silica fine particles is preferably low in terms of excellent bending resistance. The lower limit of the content of the silica fine particles is preferably not less than 20% by mass, more preferably not less than 25% by mass, and particularly preferably not less than 30% by mass. The upper limit of the content of the silica fine particles is preferably not more than 60% by mass, more preferably not more than 55% by mass, particularly preferably not more than 50% by mass, and most preferably not more than 40% by mass . According to an aspect of this invention, the content of the silica fine particles is preferably not less than 25% by mass and not more than 60% by mass, and more preferably not less than 35% by mass and not more than 55% by mass.

The film according to this embodiment may further contain an additive in addition to the components described above. Examples of the additive include a pH regulator, a silica dispersant, an ultraviolet absorbent, an antioxidant, a release agent, a stabilizer, a colorant such as a bluing agent, a flame retardant, a lubricant, and a leveling agent.

Specific examples of the additive include an alkoxysilane compound having a reactive group. Specific examples of the reactive group include a vinyl group, an epoxy group, an amino group, an ureido group, and an isocyanate group, and the amino group is preferable. The alkoxysilane compound having a reactive group may be contained in an amount of not less than 0.1 parts by mass and not more than 3 parts by mass based on 100 parts by mass of a total content of the resin and the silica fine particles.

In the film according to this embodiment, it is preferable that the total light transmittance at a film thickness of 50 μm be not less than 85%, and a haze be not more than 2.0, and it is more preferable that the total light transmittance be not less than 90%. The film having such optical characteristics is suitable for optical applications.

The thickness of the film according to this embodiment is adjusted according to characteristics required for a flexible device or the like using this film and is usually not less than 10 μm and not more than 500 μm, preferably not less than 20 μm and not more than 200 μm, more preferably not less than 30 μm and not more than 120 μm, and furthermore preferably not less than 40 μm and not more than 90 μm. In the film having such a constitution, there is a tendency that durability and bending resistance are simultaneously achieved. The film according to this embodiment is excellent in bending resistance and is particularly useful as a member of a flexible device.

The film according to this embodiment may be a laminate formed by adding a functional layer such as an ultraviolet absorption layer, a hard coat layer, an adhesive layer, and a hue adjustment layer.

A flexible device to which the film according to this embodiment is applicable is not limited to a display device. For example, the film according to this embodiment can be adopted as a front plate for a solar cell having a substrate formed with a photoelectric conversion element and a front plate provided on a substrate surface. In this case, the solar cell can have excellent bending resistance as a whole.

Next, an example of a method for producing the film according to this embodiment will be described.

The resin composition used in producing the film according to this embodiment can be prepared by, for example, mixing and stirring a reaction liquid of a polyimide-based polymer and/or polyamide, the silica fine particles, an organic solvent, and the above additive to be used if necessary. The reaction liquid is obtained by selecting and reacting the tetracarboxylic compound, the diamine, or the additive. Instead of the reaction liquid of a polyimide-based polymer and so on, a solution of a purchased polyimide-based polymer and so on or a solution of a purchased solid polyimide-based polymer and so on may be used.

The solvent contained in the resin composition according to this embodiment may be those capable of dissolving a resin. For example, if the resin is polyimide-based polymer or polyamide, it is possible to use amide-based solvents such as N,N-dimethylformamide and N,N-dimethylacetamide; lactone-based solvents such as γ-butyrolactone and γ-valerolactone; sulfur-containing-based solvents such as dimethylsulfone, dimethylsulfoxide, and sulfolane; and carbonate-based solvents such as ethylene carbonate and propylene carbonate. Among those solvents, the amide-based solvents or the lactone-based solvents are preferably used. These solvents may be used alone, or two or more kinds of them may be mixed and used.

Subsequently, the prepared resin composition is applied on a substrate by, for example, roll-to-roll or batch processing to form a coating film. The coating film is dried to form a film, and then the film is peeled from the substrate, whereby the film according to this embodiment is obtained. Examples of the substrate include a polyethylene terephthalate (PET) substrate, a SUS belt, and a glass substrate. The film may be further dried after peeling.

The formation of the film from the coating film and drying of the film are carried out by heating at a temperature of 50° C. to 350° C. to evaporate the solvent, which is contained in a varnish. If necessary, heating may be carried out in an inert gas atmosphere or under a reduced pressure condition. The solvent is preferably eliminated.

A functional layer according to this embodiment can be formed on the film according to this embodiment by, for example, roll-to-roll or batch processing.

Next, the resin composition according to this invention, a film comprising the resin composition, and an example of a method for producing the film will be described.

The resin composition according to an embodiment contains a resin containing a polyimide-based polymer and silica fine particles whose average primary particle size measured by a BET method is not less than 16 nm and not more than 40 nm and whose volume average particle size (hereinafter also referred to as a DLS size) measured by a dynamic light scattering method is not less than 25 nm and not more than 65 nm.

Specific examples and preferable examples of the polyimide-based polymer according to this embodiment are the same as those of the polyimide-based polymer described in the description of the film. The resin composition according to this embodiment may contain a resin other than the polyimide-based polymer. Specific examples and preferable examples of the resin are the same as those of the resin described in the description of the film.

As silica fine particles used for preparing the resin composition according to this embodiment, a silica sol prepared by dispersing silica fine particles in an organic solvent or the like may be used, or a silica fine particle powder produced by a gas phase method may be used. From the viewpoint of ease of handling, silica sol is preferably used.

The silica sol according to this embodiment can be prepared by various known methods such as a sol-gel method. A solvent of the silica sol can be prepared by a known solvent displacement method using vacuum concentration, ultrafiltration, or the like. Specific examples and preferable examples of dispersion media of the silica fine particles are the same as those of the solvents contained the resin composition described in the description of the film production method.

The average primary particle size of the silica fine particles can be measured by the BET method. The average primary particle size is not less than 16 nm and not more than 40 nm, preferably not less than 21 nm and not more than 40 nm, more preferably not less than 25 nm and not more than 40 nm, still more preferably not less than 25 nm and not more than 35 nm, and most preferably not less than 26 nm and not more than 33 nm.

The DLS size of the silica fine particles is the DLS size in such a state that the particles are fully diluted. When the DLS size of the silica fine particles is evaluated by a dynamic light scattering method (DLS measurement) with respect to a silica sol composition prepared through satisfactory dilution, a value allowing identification of features of the silica fine particles can be obtained. More specifically, dilution and measurement are repeated until a measured value is converged within ±1 nm, and a measured value when it is constant can be adopted. The concentration of the silica fine particles obtained at this time is typically approximately 0.02 to 0.2% by mass if the DLS size is 20 to 100 nm. The DLS size of the silica fine particles is not less than 25 nm and not more than 65 nm, preferably not less than 30 nm and not more than 60 nm, more preferably not less than 38 nm and not more than 60 nm, still more preferably not less than 38 nm and not more than 57 nm, and most preferably not less than 40 nm and not more than 53 nm.

A polydispersity index (PDI) of the silica fine particles is a parameter showing broadening of distribution of the particle size (particle size distribution) of the silica fine particles and means that the higher this value is, the broader the distribution is. If the PDI is within a range of not more than 15%, the particle size distribution of the silica fine particles suitably broadens, and while satisfactorily achieving the effect of increasing elastic modulus of a polyimide-based film due to addition of the silica fine particles, it is expected that degradation of optical properties by addition is suppressed and achieved both properties of bending resistance and transparency, even if the silica fine particles are somewhat larger. The PDI of the silica fine particles is preferably not more than 13%, more preferably not more than 11%, still more preferably not more than 9%, and particularly preferably not more than 6%.

The resin composition according to this embodiment may contain the silica fine particles in an amount of not less than 15% by mass and not more than 80% by mass based on the total content of the resin and the silica fine particles. The content of the silica fine particles is preferably high in terms of the optical characteristics such as the total light transmittance of the film and material cost, and, on the other hand, the content of the silica fine particles is preferably low in terms of excellent bending resistance. The lower limit of the content of the silica fine particles is preferably not less than 20% by mass, more preferably not less than 25% by mass, and particularly preferably not less than 30% by mass. The upper limit of the content of the silica fine particles is preferably not more than 60% by mass, more preferably not more than 55% by mass, particularly preferably not more than 50% by mass, and most preferably not more than 40% by mass . According to an aspect of this invention, the content of the silica fine particles is preferably not less than 25% by mass and not more than 60% by mass, and more preferably not less than 35% by mass and not more than 55% by mass.

The resin composition according to this embodiment further contains a solvent. The solvent used in preparation of the resin composition may be those capable of dissolving a resin. Specific examples and preferable examples of the solvent are the same as those of the solvents contained the resin composition described in the description of the film production method.

The resin composition according to this embodiment may further contain an additive. Specific examples of the additive include the additives described in the description of the film.

The resin composition according to this embodiment can be prepared by, for example, mixing and stirring a solution of a resin such as the polyimide-based polymer and polyamide to be used if necessary, the silica fine particles, the solvent, and the additive to be used if necessary.

In the film formed by using the resin composition according to this embodiment, the resin composition is applied on a substrate by, for example, roll-to-roll or batch processing to form a coating film. The coating film is dried to form a film, and then the film is peeled from the substrate, whereby the film according to this embodiment is obtained. Examples of the substrate include a polyethylene terephthalate (PET) substrate, a SUS belt, and a glass substrate. The film may be further dried after peeling. In the film production method, the roll-to-roll processing is preferable because it is useful for mass production.

The formation of the film from the coating film and drying of the film are carried out by heating at a temperature of 50° C. to 350° C. to evaporate the solvent. If necessary, heating may be carried out in an inert gas atmosphere or under a reduced pressure condition.

### EXAMPLES

Hereinafter, the present invention will be more specifically described with reference to Examples and Comparative Examples, but the present invention is not limited thereto.

### (Production of GBL-Substituted Silica Sol)

### Synthesis Examples 1 to 6

γ-butyrolactone (hereinafter also referred to as GBL)-substituted silica sols were obtained by solvent substitution using as raw materials amorphous silica sols of different average primary particle size measured by BET method produced by a sol-gel method. The obtained GBL-substituted silica sols each contain a silica component in an amount of 30 to 32% by mass, and the moisture value was not more than 1.0% by mass. A portion of amorphous silica sol as a raw material and a portion of the GBL-substituted silica sol were diluted to 0.1% by mass with distilled water, a GBL-substituted sol was subjected to DLS measurement by the dynamic light scattering method, and it was confirmed that a volume average particle size (DLS size) was equivalent to each raw material (see Table 1). Further, the polydispersity index (PDI) of the produced GBL-substituted sol was evaluated. As an analyzer for the DLS size and the polydispersity index, Zetasizer Nano ZS (manufactured by Malvern Instruments Ltd.) was used.

TABLE 1

| | BET size | DLS size | | DLS size | |
|---|---|---|---|---|---|
| | of raw | of raw | Grade name | of GBL- | |
| Syn- | material | material | of GBL- | substituted | PDI of GBL- |
| thesis | silica | silica | substituted | silica | substituted |
| example | sol/nm | sol/nm | silica sol | sol/nm | silica sol/% |
| 1 | 12 | 23 | GBL sol 1 | 23 | 16 |
| 2 | 16 | 27 | GBL sol 2 | 27 | 11 |
| 3 | 21 | 33 | GBL sol 3 | 33 | 9 |
| 4 | 28 | 43 | GBL sol 4 | 43 | 6 |
| 5 | 35 | 55 | GBL sol 5 | 55 | 4 |
| 6 | 47 | 70 | GBL sol 6 | 70 | 7 |

### (Polyimide-Based Polymer)

A GBL solution of a resin A and a resin B were purchased. A resin C was synthesized.
Resin A: “Neopulim 6A20S” (glass transition temperature: 390° C.) manufactured by Mitsubishi Gas Chemical Co., Inc.
Resin B: “KPI-MX300F (100)” manufactured by Kawamura Sangyo Co., Ltd.
Resin C: polyimide which is a copolymer of bicyclo[2.2.2]oct-7-ene-2,3,5,6-tetracarboxylic dianhydride, 4,4′-bis(4-aminophenoxy)biphenyl, and 2,2-bis[4-(4-aminophenoxy)phenyl]propane

### Synthesis Example 7

The resin B was dissolved in GBL to obtain a GBL solution.

### Synthesis Example 8

A resin which is a polyimide-based polymer was synthesized in conformity to the publicly known document (for example, U.S. Pat. No. 8,207,256B2). 75.0 g of bicyclo[2.2.2]oct-7-ene-2,3,5,6-tetracarboxylic dianhydride, 76.4 g of 4,4′-bis(4-aminophenoxy)biphenyl, 36.5 g of 2,2-bis[4-(4-aminophenoxy)phenyl]propane, 438.4 g of GBL, and 1.50 g of 1-ethylpiperidine were introduced into a nitrogen-substituted polymerization tank. The mixture was stirred at an internal temperature of 40° C. to prepare a solution, and then the temperature was raised to an internal temperature of 200° C. while distilling off water in the solution.

The temperature was held at 200° C. for 4 hours, and then 313.2 g of N,N-dimethylacetamide (hereafter referred to as DMAc) was added while decreasing the temperature, thus obtaining a GBL/DMAc solution of the resin C.

### Examples 1 to 17 and Comparative Examples 1 to 7

The GBL-substituted silica sol obtained in Synthesis Examples 1 to 6, an N,N-dimethylacetoamide solution of alkoxysilane having an amino group, and GBL were added to the solution of the polyimide resin to be satisfactorily mixed, and thus to obtain a resin/silica mixture varnish (hereinafter also referred to as mixture varnish) in which a mass ratio of resin and silica was changed (see Table 2). A feed ratio of raw materials in this case was adjusted such that the mass ratio of GBL and DMAc in the mixture varnish was 85:15 and the amount of alkoxysilane having an amino group was 1.67 parts by mass based on 100 parts by mass of a total of the resin and silica. The obtained mixture varnish was filtered by a filter having a mesh opening of 10 μm, then applied on a polyethylene terephthalate film having a film thickness of 188 and then dried at a temperature from 50° C. to 140° C. A self-supporting resin was fixed to a metal frame to be dried at 210° C., and thus to obtain a film having a film thickness of 50 μm.

### (Evaluation Method)

The optical characteristics and bending resistance of each of the films obtained in Examples 1 to 17 and Comparative Examples 1 to 7 were judged by the following evaluation method. In addition, stability of viscosity of each of the mixture varnishes of Examples 5 to 8 and Comparative Examples 3 and 4 was judged by the following evaluation method. Table 2 and 3 show the evaluation results.

### A. Optical Characteristics

The transparency, the total light transmittance, and the YI value were evaluated, and when all evaluation results were judged as ◯, the optical characteristics were evaluated as good and it is represented as ◯ in Table 2, and the other cases were judged as inferior and it is represented as x in Table 2. The method of evaluating the transparency, the total light transmittance, and the YI value and the evaluation criteria are as follows.

a. Transparency

A film was cut into a size of 30 mm×30 mm, and a haze (%) was measured using a haze computer (HGM-2DP manufactured by Suga Test Instruments Co., Ltd.) and judged based on the following criteria.

◯: haze is not more than 2.0% and evaluated as good.

×: haze is more than 2.0% and evaluated as inferior.

b. Total Light Transmittance

A film was cut into a size of 30 mm×30 mm, and the total light transmittance (%) was measured using a haze computer (HGM-20P manufactured by Suga Test Instruments Co., Ltd.) and judged based on the following criteria.

◯: transmittance is not less than 85% and evaluated as good.

×: transmittance is less than 85% and evaluated as inferior.

c. Yellow Index (YI Value)

A film was cut into a size of 30 minx 30mm, and tristimulus values (X, Y, and Z) were obtained using a UV-VIS-NIR spectrophotometer (V-670 manufactured by JASCO Corporation) to be substituted into the following calculation formula, and thus to calculate the YI value.

YI=100×(1.2769X−1.0592Z)/Y

The evaluation was judged based on the following criteria.

◯: YI value is not more than 4.0 and evaluated as good.

×: YI value is more than 4.0 and evaluated as inferior.

### B. Bending Resistance

A film was cut into a strip shape of 10 mm×100 mm with the use of a dumbbell cutter. The cut film was set in a main body of an MIT folding endurance tester (MIT-DA manufactured by Toyo Seiki Seisaku-sho, Ltd.), and bending strength in both front and rear directions which was measured under conditions of a test speed of 175 cpm, a bending angle of 135°, a load of 750 g, and a curvature radius R of a bending clamp being 2.0 mm was shown as bending number of times until breaking. As the evaluation criteria, there was calculated a value (hereinafter also referred to as relative bending resistance) obtained by dividing a bending endurance time of the film obtained in each example by a bending endurance time of a film in which the kind of resin and the mass ratio of polyimide and silica were the same and a film in which a grade of GBL-substituted silica sol was GBL sol 3 was as a standard, and the bending resistance was judged based on the following criteria(in Table 2).

A: relative bending resistance>1.2 and evaluated as excellent.

B: 1.2≧relative ≧bending resistance≧1.0 and evaluated as good.

C: 1.0>relative bending resistance≧0.8 and evaluated as generally good.

D: 0.8>relative bending resistance and evaluated as inferior.

### C. Varnish Stability

After lapses of 3 to 4 hours and 27 to 28 hours from preparation, the viscosity of a mixture varnish was measured by using an E-type viscometer (DV-2+Pro VISCOMETER manufactured by Brookfield Engineering Laboratories, Inc.; size of used cone: CPE-52) under conditions of a rotation speed of 0.3 rpm and a room temperature of 25° C., the degree of an increase in viscosity per 24 hours (this degree is hereinafter also referred to as a degree of viscosity increase) was calculated, and the varnish stability was judged based on the following criteria (in Table 2). Suppression of an increase of the viscosity of the mixture varnish facilitates stabilization of a film thickness in film formation.

⊚: 1.1≧degree of viscosity increase≧0.9 and evaluated as excellent.

◯: 2.0≧degree of viscosity increase≧1.1 and evaluated as good.

×: degree of viscosity increase>2.0 and evaluated as inferior.

TABLE 2

| | | | Grade name of | | | Viscosity |
|---|---|---|---|---|---|---|
| | | | GBL- | | | stability of |
| | Mass ratio | | substituted | Optical | Bending | mixture |
| | (polyimide:silica) | Resin | silica sol | characteristics | resistance | varnish |
| Comparative | 70:30 | A | GBL SOL 1 | ◯ | D | — |
| Example 1 | | | | | | |
| Example 1 | 70:30 | A | GBL SOL 2 | ◯ | C | — |
| Example 2 | 70:30 | A | GBL SOL 3 | ◯ | B | — |
| Example 3 | 70:30 | A | GBL SOL 4 | ◯ | A | — |
| Example 4 | 70:30 | A | GBL SOL 5 | ◯ | A | — |
| Comparative | 70:30 | A | GBL SOL 6 | X | A | — |
| Example 2 | | | | | | |
| Comparative | 60:40 | A | GBL SOL 1 | ◯ | D | ◯ |
| Example 3 | | | | | | |
| Example 5 | 60:40 | A | GBL SOL 2 | ◯ | C | ◯ |
| Example 6 | 60:40 | A | GBL SOL 3 | ◯ | B | ◯ |
| Example 7 | 60:40 | A | GBL SOL 4 | ◯ | A | ⊙ |
| Example 8 | 60:40 | A | GBL SOL 5 | ◯ | A | ⊙ |
| Comparative | 60:40 | A | GBL SOL 6 | X | A | ⊙ |
| Example 4 | | | | | | |
| Example 9 | 80:20 | B | GBL SOL 3 | ◯ | B | — |
| Example 10 | 80:20 | B | GBL SOL 4 | ◯ | A | — |
| Example 11 | 80:20 | B | GBL SOL 5 | ◯ | A | — |
| Example 12 | 50:50 | B | GBL SOL 3 | ◯ | B | — |
| Example 13 | 50:50 | B | GBL SOL 4 | ◯ | A | — |
| Example 14 | 50:50 | B | GBL SOL 5 | ◯ | A | — |
| Comparative | 50:50 | B | GBL SOL 6 | X | A | — |
| Example 5 | | | | | | |
| Comparative | 40:60 | C | GBL SOL 1 | ◯ | D | — |
| Example 6 | | | | | | |
| Example 15 | 40:60 | C | GBL SOL 3 | ◯ | B | — |
| Example 16 | 40:60 | C | GBL SOL 4 | ◯ | A | — |
| Example 17 | 40:60 | C | GBL SOL 5 | ◯ | A | — |
| Comparative | 40:60 | C | GBL SOL 6 | X | A | — |
| Example 7 | | | | | | |

TABLE 3

| | | | | Bending endurance |
|---|---|---|---|---|
| | Total Light | | | time |
| | Transmittance | Transparency | YI | (×10³ times) |
| Comparative | 91 | 0.8 | 1.7 | 78 |
| Example 1 | | | | |
| Example 1 | 91 | 0.8 | 1.7 | 123 |
| Example 2 | 91 | 0.8 | 1.8 | 160 |
| Example 3 | 91 | 0.9 | 1.9 | ≧300 |
| Example 4 | 91 | 1.1 | 2.5 | ≧300 |
| Comparative | 90 | 3.6 | 7.5 | ≧300 |
| Example 2 | | | | |
| Comparative | 92 | 0.8 | 1.5 | 28 |
| Example 3 | | | | |
| Example 5 | 92 | 0.8 | 1.5 | 60 |
| Example 6 | 92 | 0.8 | 1.6 | 84 |
| Example 7 | 92 | 1.0 | 1.8 | ≧200 |
| Example 8 | 91 | 1.2 | 2.6 | ≧200 |
| Comparative | 91 | 3.8 | 8.3 | ≧200 |
| Example 4 | | | | |
| Example 9 | 91 | 0.8 | 1.8 | 240 |
| Example 10 | 91 | 0.8 | 1.9 | ≧400 |
| Example 11 | 91 | 1.0 | 3.0 | ≧400 |
| Example 12 | 92 | 0.8 | 1.8 | 68 |
| Example 13 | 92 | 0.9 | 2.0 | 152 |
| Example 14 | 92 | 1.0 | 2.6 | ≧200 |
| Comparative | 92 | 3.5 | 8.2 | ≧200 |
| Example 5 | | | | |
| Comparative | 92 | 0.9 | 1.9 | 42 |
| Example 6 | | | | |
| Example 15 | 92 | 0.9 | 2.0 | 114 |
| Example 16 | 92 | 1.0 | 2.2 | ≧200 |
| Example 17 | 92 | 1.1 | 2.4 | ≧200 |
| Comparative | 91 | 3.1 | 7.7 | ≧200 |
| Example 7 | | | | |

### D. Average Primary Particle Size of Silica Fine Particles in Film (SEM Image Analysis)

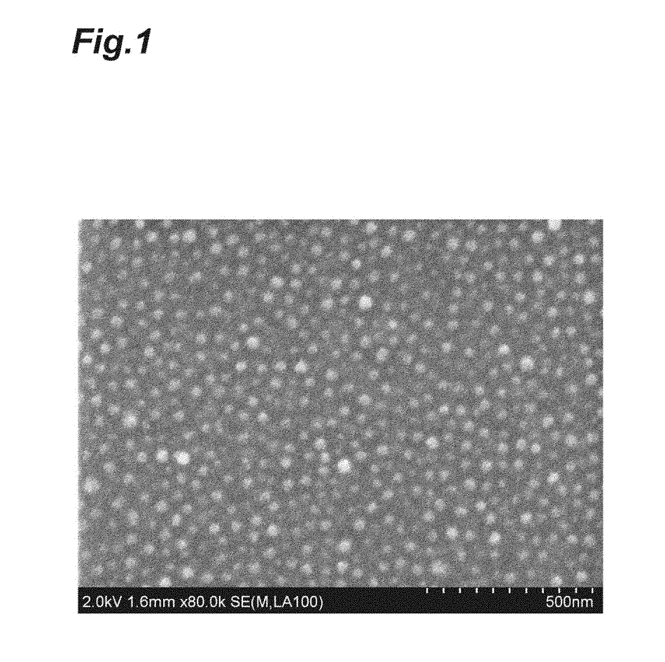

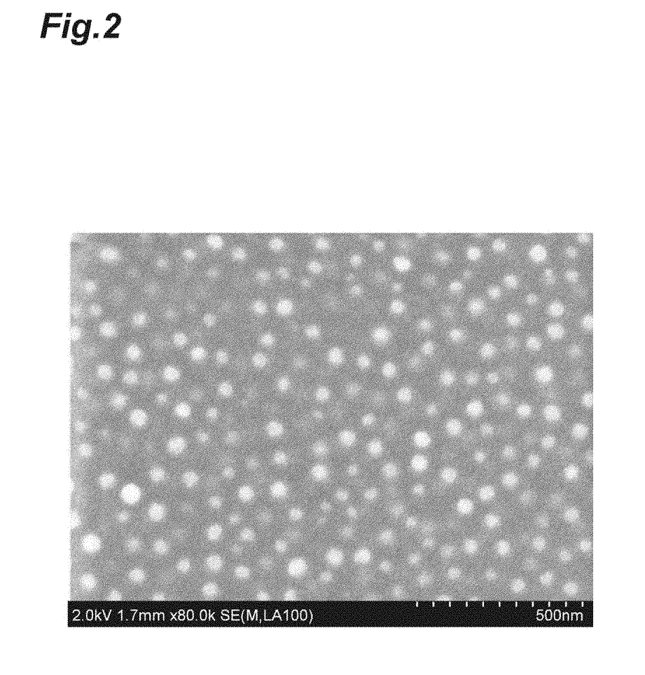

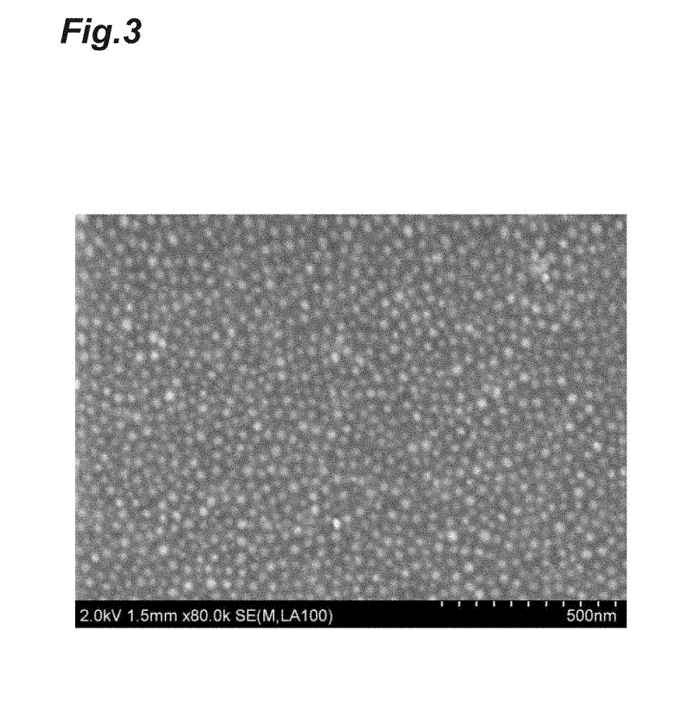

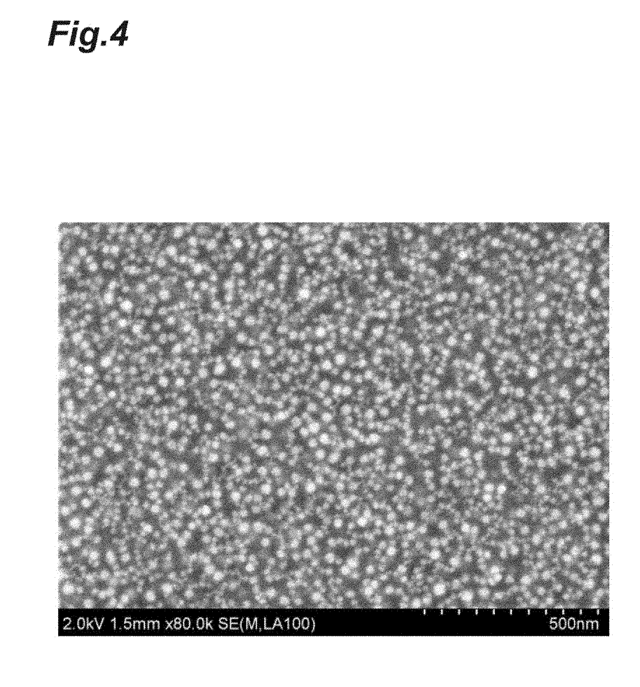

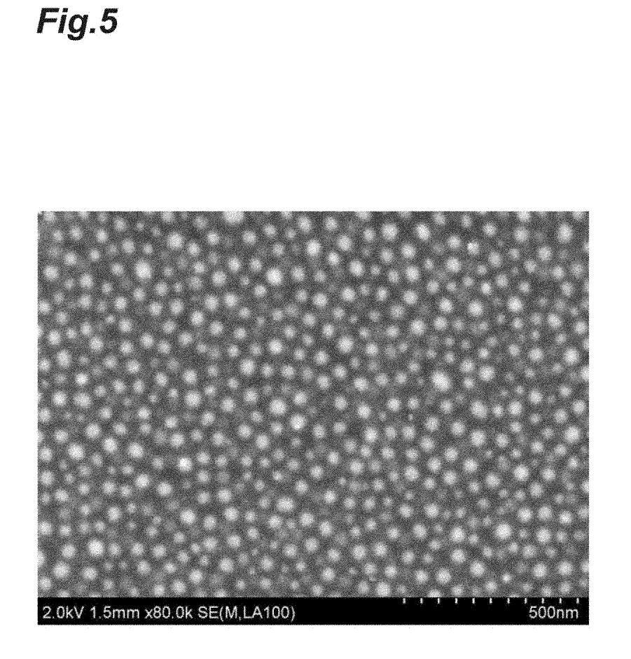

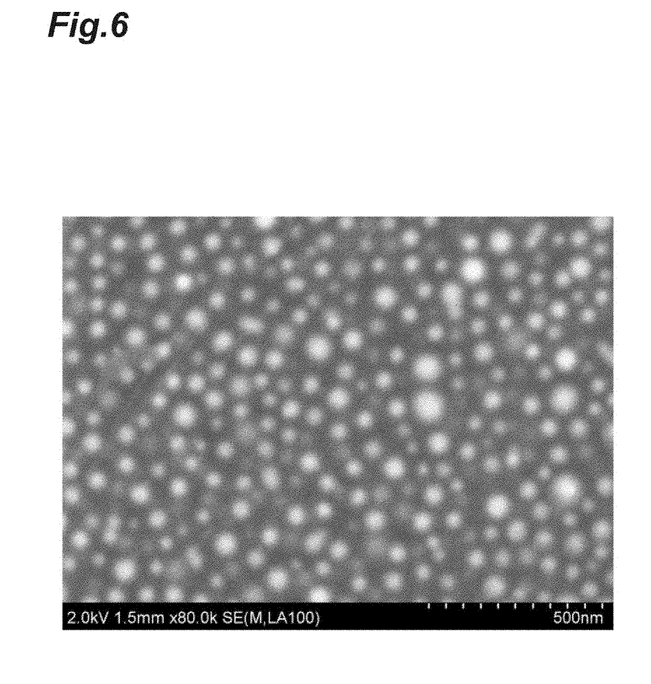

In the films obtained in Examples 2 and 4 through 7, and Comparative Example 4, the average primary particle size of silica fine particles in each film was confirmed by the following evaluation method and evaluation criteria. FIGS. 1 through 6 show SEM images of the films obtained in Examples 2, 4 through 7, and Comparative Example 4, respectively. Table 4 shows the results of measurement of the average primary particles size.

The SEM images (image roughness: 1.24 nm/pix) of the films obtained in Examples 2 and 4 through 7, and Comparative Example 4 were acquired, and the average particle size was analyzed using an image analysis software (name of software program: Image J).

### <SEM Observation Conditions>

Apparatus: S4800 (manufactured by Hitachi High-Technologies Corporation)
Acceleration voltage: 2 kV
Work Distance: 1.5 mm
Observation magnification: ×80 k

### <Image Analysis Conditions>

Filter: median 2pix
Binarization: Auto Threshold Otsu
Analysis range: 1200 pix×860 pix (x=70 to 1270 pix, y=20 to 880 pix)
Analyze Particle: Exclude on edges, Include holes

Particles in which Area>25 pix was subjected to elliptic approximation, and the major axis and the minor axis were calculated. Then, an average value of the major axis and the minor axis was calculated as the average primary particle size. The average primary particle size measured by this evaluation method showed a relationship represented by the following formula to BET size of raw materials silica sols.

Average primary particle size=BET size×0.7+11

Table 4 shows the average primary particle size and the calculated value from the above formula. A standard deviation of the average primary particle size was calculated, and then this value was divided by the average primary particle size to calculate a variation coefficient. The variation coefficient was not less than 0.2 and not more than 0.5. Each the average primary particle size of Examples 1, 3, 8 through 17, Comparative Examples 1 through 3, and 5 through 7 are an average primary particle size corresponding to GBL sol which is used in the producing of the film.

TABLE 4

| | | Average | | |
|---|---|---|---|---|
| | | primary | | Calculated value of |
| | | particle size | Variation | average primary |
| | GBL sol | (nm) | coefficient | particle size |
| Example 2 | GBL sol 3 | 25 | 0.34 | 26 |
| Example 4 | GBL sol 5 | 36 | 0.31 | 36 |
| Example 5 | GBL sol 2 | 22 | 0.34 | 22 |
| Example 6 | GBL sol 3 | 26 | 0.44 | 26 |
| Example 7 | GBL sol 4 | 32 | 0.24 | 31 |
| Comparative | GBL sol 6 | 43 | 0.28 | 44 |
| Example 4 | | | | |

What is claimed is:

1. An optical film comprising: a resin; and silica fine particles whose average primary particle size measured by image analysis with a scanning electron microscope is not less than 21 nm and not more than 40 nm, wherein
the content of the silica fine particles is not less than 15% by mass and not more than 80% by mass based on a total content of the resin and the silica fine particles.

2. The optical film according to claim 1, wherein the resin contains a polyimide-based polymer.

3. The optical film according to claim 1, wherein the average primary particle size of the silica fine particles measured by image analysis with a scanning electron microscope is not less than 25 nm and not more than 40 nm.

4. The optical film according to claim 1, wherein a variation coefficient of the silica fine particles obtained by image analysis with a scanning electron microscope is more than 0 and not more than 0.5.

5. The optical film according to claim 1, wherein a content of the silica fine particles is not less than 25% by mass and not more than 60% by mass based on a total content of the resin and the silica fine particles.

6. The optical film according to claim 1, further comprising an alkoxysilane compound having a reactive group and contained in an amount of not less than 0.1 parts by mass and not more than 3 parts by mass based on 100 parts by mass of a total content of the resin and the silica fine particles.

7. The optical film according to claim 1, wherein a total light transmittance at a film thickness of 50 μm is not less than 85%, and a haze is not more than 2.0.

8. The optical film according to claim 1, wherein a film thickness is not less than 20 μm and not more than 200 μm.

9. A flexible device member comprising the optical film according to claim 1.

10. A resin composition comprising: a resin containing a polyimide-based polymer; and silica fine particles whose average primary particle size measured by a BET method is not less than 16 nm and not more than 40 nm and a volume average particle size measured by a dynamic light scattering method is not less than 25 nm and not more than 65 nm.

11. The resin composition according to claim 10, wherein the content of the silica fine particles is not less than 15% by mass and not more than 80% by mass based on a total content of the resin and the silica fine particles.

12. The polyimide-based resin composition according to claim 10, wherein a polydispersity index of the volume average particle size of the silica fine particles measured by the dynamic light scattering method is not more than 15%.

13. An optical film comprising the polyimide-based resin composition according to claims 10.

14. The optical film according to claim 2, wherein the average primary particle size of the silica fine particles measured by image analysis with a scanning electron microscope is not less than 25 nm and not more than 40 nm.

15. The optical film according to claim 2, wherein a variation coefficient of the silica fine particles obtained by image analysis with a scanning electron microscope is more than 0 and not more than 0.5.

16. The optical film according to claim 2, wherein a content of the silica fine particles is not less than 25% by mass and not more than 60% by mass based on a total content of the resin and the silica fine particles.

17. The optical film according to claim 2, further comprising an alkoxysilane compound having a reactive group and contained in an amount of not less than 0.1 parts by mass and not more than 3 parts by mass based on 100 parts by mass of a total content of the resin and the silica fine particles.

18. The optical film according to claim 14, wherein a variation coefficient of the silica fine particles obtained by image analysis with a scanning electron microscope is more than 0 and not more than 0.5.

19. The optical film according to claim 18, wherein a content of the silica fine particles is not less than 25% by mass and not more than 60% by mass based on a total content of the resin and the silica fine particles.

20. The polyimide-based resin composition according to claim 11, wherein a polydispersity index of the volume average particle size of the silica fine particles measured by the dynamic light scattering method is not more than 15%.
